(19) United States
(12) Patent Application Publication
(10) Pub. No.: US 2011/0187554 A1
(43) Pub. Date: Aug. 4, 2011

(54) INTEGRATED PERMANENT MONITORING SYSTEM

(75) Inventors: Emmanuel Rioufol, Eysines (FR); Didier Pohl, Paris (FR)

(73) Assignee: SCHLUMBERGER TECHNOLOGY CORPORATION, SUGAR LAND, TX (US)

(21) Appl. No.: 12/827,899

(22) Filed: Jun. 30, 2010

Related U.S. Application Data
(60) Provisional application No. 61/299,684, filed on Jan. 29, 2010.

(51) Int. Cl. G01V 3/00; E21B 47/00

(52) U.S. Cl. 340/853.2; 166/66

(57) ABSTRACT

A technique facilitates monitoring of parameters in a well environment. At least one sensor is positioned downhole in a wellbore to measure a desired parameter or parameters. Data from the sensor is sent uphole to an electrical wellhead outlet which is integrated into the wellhead. The wellhead and integrated electrical wellhead outlet provide a simple system architecture that may be used to process well parameter data as desired.

### BACKGROUND

In many well applications, sensors are used to monitor various downhole parameters. The sensors are deployed downhole in a wellbore and parameter data is relayed uphole to an independent surface acquisition box. The data may then be observed and/or processed to monitor and evaluate certain aspects of the well system. However, the independent surface acquisition box and associated system architecture can create substantial complexity and cost.

### SUMMARY

In general, the present invention comprises a system and methodology for monitoring parameters in a well environment. At least one sensor is positioned downhole in a wellbore to measure a desired parameter or parameters. Data from the sensor is sent uphole to an electrical wellhead outlet which is integrated into the wellhead. The data may be processed as desired at the electrical wellhead outlet. In some applications, the electrical wellhead outlet is used to transmit the data wirelessly to a surface data gateway.

### BRIEF DESCRIPTION OF THE DRAWINGS

Certain embodiments of the invention will hereafter be described with reference to the accompanying drawings, wherein like reference numerals denote like elements, and:

FIG. 1 is a schematic view of a well system having a wellhead with an integrated electrical wellhead outlet positioned over a wellbore, according to an embodiment of the present invention;

FIG. 2 is a schematic illustration of one example of an electrical wellhead outlet that may be integrated into the wellhead, according to an embodiment of the present invention;

FIG. 3 is a schematic illustration of the wellhead and integrated electrical wellhead outlet communicating wirelessly with one embodiment of a surface data gateway, according to an embodiment of the present invention; and

FIG. 4 is a schematic illustration of the wellhead and integrated electrical wellhead outlet communicating wirelessly with another embodiment of a surface data gateway, according to an alternate embodiment of the present invention.

### DETAILED DESCRIPTION

In the following description, numerous details are set forth to provide an understanding of the present invention. However, it will be understood by those of ordinary skill in the art that the present invention may be practiced without these details and that numerous variations or modifications from the described embodiments may be possible.

The present invention generally relates to a system for monitoring one or more desired parameters downhole in a well. According to one embodiment described below, the monitoring system is a permanent monitoring system having a highly simplified surface architecture. An electrical wellhead outlet is integrated into a wellhead and is capable of carrying out the functions otherwise performed by an independent surface acquisition box. For example, the electrical wellhead outlet may be a wireless wellhead outlet which enables elimination of wiring between the wellhead and a separate data acquisition system. Additionally, the electrical wellhead outlet may integrate a power supply for providing power to a downhole monitoring system. The simplified system architecture facilitates installation and surface system integration while providing substantial cost reductions compared to traditional wired systems.

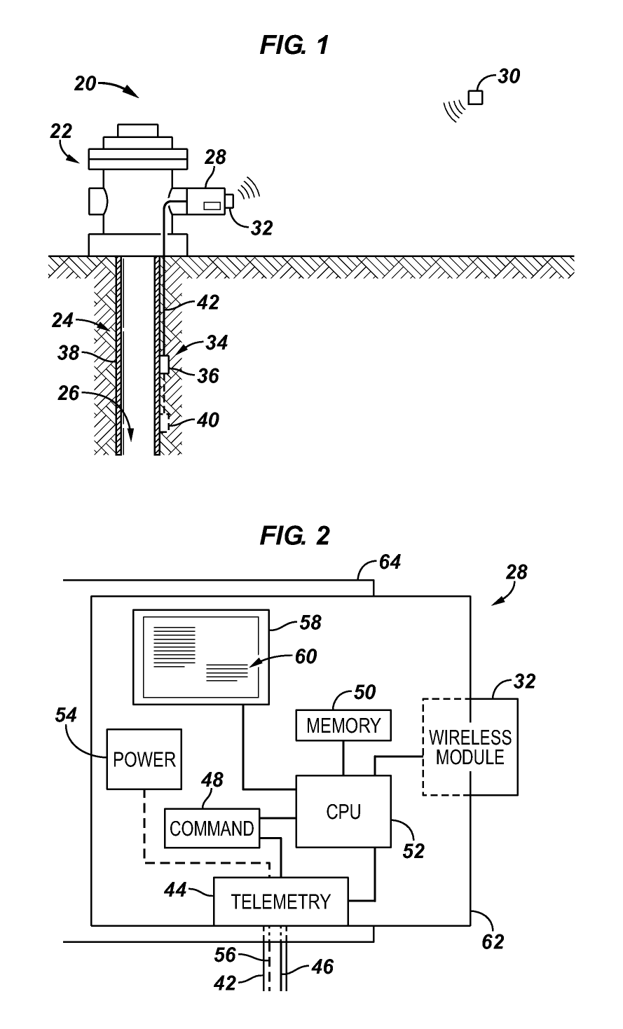

Referring generally to FIG. 1, one example of a generic well system 20 is illustrated as comprising a wellhead 22 positioned over a well 24 having a wellbore 26. Additionally, an electrical wellhead outlet 28 is integrated into the wellhead 22 to relay well related data to a desired external system 30, such as a surface data gateway. By way of example, the electrical wellhead outlet 28 may comprise a wireless module 32 designed to communicate wirelessly with the data gateway 30. In an alternate embodiment, module 32 may be formed as a plug module (or formed to include a plug module) to enable temporary or permanent connection to a hard wire for relaying data to the external system.

In the embodiment illustrated, well system 20 further comprises a downhole monitoring system 34 designed to detect and/or monitor one or more desired downhole parameters. The downhole monitoring system 34 transmits data uphole to electrical wellhead outlet 28. By way of example, downhole monitoring system 34 comprises a sensor 36, such as a sensor gauge. Depending on the specific embodiment, sensor 34 may comprise a pressure gauge, a temperature gauge, or a combined pressure and temperature gauge designed to detect pressure and/or temperature at the desired position along the wellbore 26. In some embodiments, sensor 36 is deployed outside of a tubing 38, e.g. a production tubing, an injection tubing or a casing, that extends downhole. Additionally, downhole monitoring system 34 may comprise a plurality of sensors by adding one or more additional sensors 40. According to one embodiment, one or more sensors 36, 40 may be positioned outside of tubing 38, in this embodiment outside a well casing, to monitor the geological formation and/or fluids. Other sensors may be located within tubing 38 or at other desired downhole locations.

As illustrated, the downhole monitoring system 34 is connected with electric wellhead outlet 28 by a cable 42. Cable 42 is designed as an instrumentation cable able to convey information up to the wellhead 22 at a surface location. However, cable 42 also may be used to deliver power to downhole monitoring system 34 to power the downhole sensors if the downhole sensors are not self powered via, for example, a downhole battery. In the example illustrated, cable 42 comprises a permanent cable deployed between the electrical wellhead outlet 28 and downhole monitoring system 34. Cable 42 may be connected to an individual sensor or to a plurality of sensors, e.g. sensors 36, 40.

Referring generally to FIG. 2, one embodiment of electrical wellhead outlet 28 is illustrated. In this embodiment, the electrical wellhead outlet 28 has substantial data handling capability integrated into wellhead 22. By way of example, the electrical wellhead outlet 28 may comprise a downhole monitoring telemetry acquisition system 44, such as a downhole sensor gauge telemetry system, coupled with downhole monitoring system 34. The telemetry acquisition system 44 may be coupled with the downhole monitoring system 34 via a data communication line 46 contained within cable 42. Well parameter data sent uphole from downhole monitoring system 34 is received and managed by the telemetry acquisition system 44.

The integrated electrical wellhead outlet 28 also may comprise a downhole monitoring system command module 48 for providing control signals downhole to monitoring system 34. The wellhead outlet 28 may further comprise a data memory module 50 which works in cooperation with a central processing unit 52 (CPU), such as a microprocessor. The downhole monitoring telemetry system 44 and command module 48 also may be coupled with processing unit 52 to enable the desired accumulation, manipulation, conversion, and/or analysis of data received from, or sent to, the downhole monitoring system 34. The central processing unit 32 also may be coupled with wireless module 32 to facilitate the wireless transmission of data to external system 30, such as a data gateway.

In some applications, electrical wellhead outlet 28 further comprises a power supply 54 used to provide power to downhole monitoring system 34. By way of example, power supply 54 is connected to one or more sensors 36, 40 via a power supply line 56 that may be contained within cable 42. Depending on the application, power supply 54 may be positioned at other locations within wellhead 22 or proximate wellhead 22. By way of example, power supply 54 may comprise a battery and/or a solar panel.

In the embodiment illustrated, the wellhead outlet 28 also comprises a surface readout panel 58 for displaying well parameter data and/or allowing input of data related to the monitoring of wellbore parameters. By way of example, surface readout panel 58 utilizes a graphical user interface 60 or other suitable interface to facilitate the display and/or input of data. In the embodiment illustrated in FIG. 2, the electrical wellhead outlet 28 also comprises an explosion-proof enclosure 62 designed according to the applicable industry standards for certain applications. Similarly, a pressure barrier 64 may be appropriately positioned between wellhead 22 and a surface environment according to the applicable industry standards for certain applications.

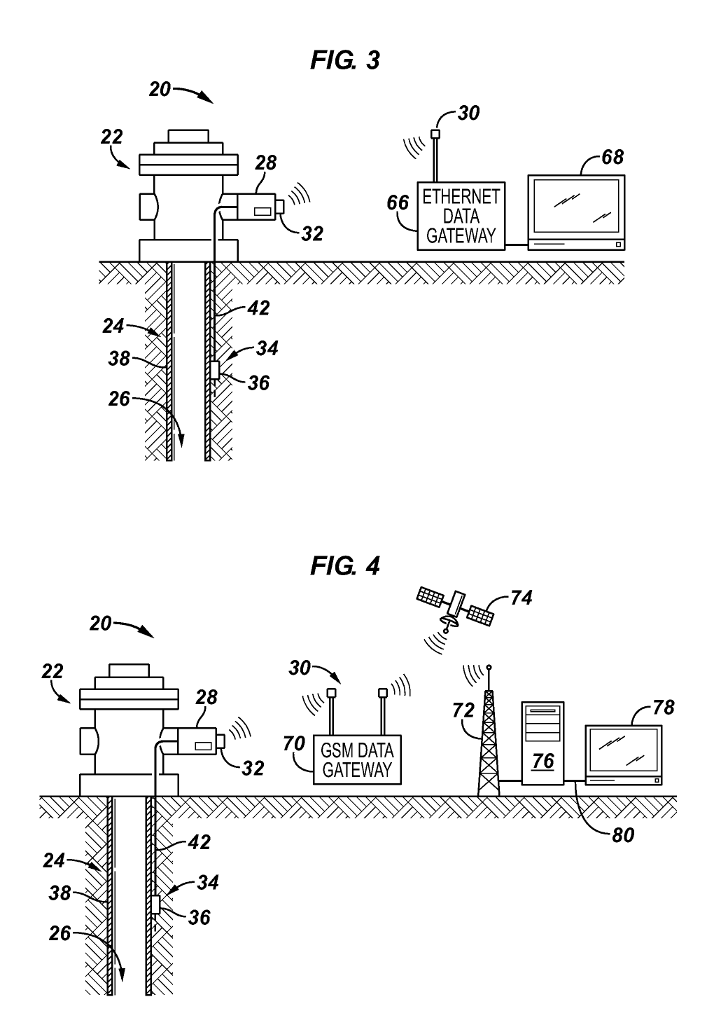

Wellhead 22 and its integrated electrical wellhead outlet 28 may be used in cooperation with a variety of external data handling systems. As illustrated in FIG. 3, for example, the electrical wellhead outlet 28 may be coupled in wireless communication with external system 30 comprising an ethernet data gateway 66. In this example, the overall well system 20 comprises a stand-alone data acquisition system which allows ethernet data gateway 66 to collect data from the field within the radius of communication of integrated wellhead outlet 28. The ethernet data gateway may be connected to one or more local computers 68 for data consultation, archiving, overall system set up, and/or other data handling functionality.

In another embodiment, wellhead 22 and its integrated electrical wellhead outlet 28 are coupled in wireless communication with external system 30 comprising a global system for mobile communications (GSM) data gateway 70. In this example, the GSM data gateway 70 is used to relay data from wellhead outlet 28 over potentially substantial distances with the aid of a data transmission system, such as a tower-based system 72 or a satellite-based system 74. The data may be relayed to an intermediate web server 76 used to collect the well parameter data and to make the well parameter data accessible to one or more computers 78 via, for example, a web based interface 80. The wireless gateway may be either self powered, e.g. battery, solar panel, or other suitable power source, or may use the local power supply if available.

The actual design of overall well system 20, including the design of wellhead 22 and its integrated electrical wellhead outlet 28, may vary according to the well monitoring application and environment. For example, depending on the telemetry and the operator requirements, more than one sensor gauge may be installed in well 24. In some applications, a multidrop system may be utilized. Additionally, the one or more sensors, e.g. sensors 36, 40, may comprise pressure sensors, temperature sensors, or other types of sensors developed for production and reservoir diagnostics. For example, the sensors may comprise ultrasonic sensors, acoustic sensors, pH-meters, pressure delta sensors, resistive sensors, capacitive sensors, and other sensors or combinations of sensors as desired for a given application.

In many applications, it is desirable to utilize sensors designed for low power consumption to enable long-term battery operation. As described above, some embodiments of electric wellhead outlet 28 contain power supply 54, e.g. a battery system, designed to ensure long term operation of downhole monitoring system 34. By way of example, the illustrated power supply 54 may comprise replaceable batteries and/or a solar panel integrated with the wellhead outlet 28.

Additionally, communication between the electrical wellhead outlet 28 and the external system 30, e.g. data gateway, may be accomplished according to a variety of methods. In one embodiment, the wireless communication may comprise a WIFI network for local communication of data. In another example, the wireless module 32 of wellhead outlet 28 may comprise a GSM communication module directly linked with a GSM antenna without requiring an intermediate data gateway. Furthermore, the wireless module 32 may be utilized to communicate additional data to the external system. For example, one of the sensors 36, 40 may be positioned at a surface location to acquire measurements at the wellhead level, and this data may be communicated to the desired data gateway.

The well system 20 enables a monitoring system that requires no surface wiring by utilizing a highly simplified surface architecture. Consequently, lower costs are associated with both the hardware and the installation while enabling quicker installation times. In some applications, certain permanent surface acquisition/data relay systems can be eliminated by allowing the electrical wellhead outlet 28 to acquire data autonomously. In this embodiment, data is downloaded from the integrated wellhead outlet 28 when required on, for example, a periodic basis.

Accordingly, well monitoring system 20 may be constructed in a variety of configurations for use with many types of well systems in many types of environments. The wellhead configuration, downhole equipment, monitoring system configuration, and data relay equipment may be adjusted according to the desired application. Furthermore, data may be collected and saved in the wellhead for periodic download; or the monitored well parameter data may be selectively or automatically relayed to external locations via, for example, wireless communication techniques. Furthermore, the techniques may be used in many types of wells, including oil and gas wells, geothermal wells, water wells, and other types of well applications.

Although only a few embodiments of the present invention have been described in detail above, those of ordinary skill in the art will readily appreciate that many modifications are possible without materially departing from the teachings of this invention. Accordingly, such modifications are intended to be included within the scope of this invention as defined in the claims.

What is claimed is:

1. A system for monitoring in a well, comprising:
a downhole monitoring system;
a cable coupled to the downhole monitoring system; and
a wellhead having an electrical wellhead outlet connected to the cable, the electrical wellhead outlet comprising:
a downhole monitoring telemetry acquisition system; and
a power supply for the downhole monitoring system.

2. The system as recited in claim 1, wherein the electrical wellhead outlet comprises a downhole monitoring system command.

3. The system as recited in claim 1, wherein the electrical wellhead outlet comprises a data memory.

4. The system as recited in claim 1, wherein the electrical wellhead outlet comprises a wireless communication module to communicate data wirelessly to an external system.

5. The system as recited in claim 2, wherein the downhole monitoring system comprises a sensor gauge.

6. The system as recited in claim 2, wherein the downhole monitoring system comprises a plurality of sensor gauges.

7. The system as recited in claim 2, wherein the downhole monitoring system comprises a temperature sensor.

8. The system as recited in claim 2, wherein the downhole monitoring system comprises a pressure sensor.

9. The system as recited in claim 1, wherein the cable comprises a data communication line and a power communication line.

10. The system as recited in claim 1, wherein the electrical wellhead outlet further comprises at least one pressure barrier between the wellhead and an external environment.

11. The system as recited in claim 1, wherein the electrical wellhead outlet further comprises a plug for coupling with a hard wire to communicate data to an external system.

12. The system as recited in claim 1, wherein the electrical wellhead outlet further comprises an explosion-proof enclosure.

13. A method of downhole monitoring, comprising:
placing a monitoring sensor downhole in a wellbore that extends from a wellhead;
routing a permanent cable from the monitoring sensor to the wellhead;
coupling a wireless wellhead outlet to the permanent cable; and
integrating downhole sensor gauge telemetry acquisition, downhole sensor command, data memory, and wireless communication capability into the wireless wellhead outlet.

14. The method as recited in claim 13, further comprising communicating downhole data wirelessly from the wireless wellhead outlet to an ethernet data gateway.

15. The method as recited in claim 13, further comprising communicating downhole data wirelessly from the wireless wellhead outlet to a GSM data gateway.

16. The method as recited in claim 13, wherein integrating comprises integrating a power supply into the wireless wellhead outlet to power the monitoring sensor.

17. The method as recited in claim 13, wherein placing comprises placing the monitoring sensor outside of a tubing used to flow fluids along the wellbore.

18. The method as recited in claim 13, wherein placing comprises placing a sensor outside of a casing to monitor parameters related to a geological formation.

19. A system for downhole monitoring, comprising:
an electrical wellhead outlet comprising a downhole sensor gauge telemetry acquisition system, a downhole sensor command system, and a wireless communication system to provide downhole data to an external data system.

20. The system as recited in claim 19, wherein the electrical wellhead outlet is mounted in a wellhead.

21. A method, comprising:
monitoring a downhole parameter with a sensor positioned in a wellbore;
sending data from the sensor to an electrical wellhead outlet mounted in a wellhead;
processing the data; and
using the electrical wellhead outlet to transmit the processed data wirelessly to a surface data gateway.

22. The method as recited in claim 21, wherein monitoring comprises monitoring temperature downhole.

23. The method as recited in claim 21, further comprising incorporating at least one of a battery or a solar panel power supply into the electrical wellhead outlet to power the sensor.

24. The method as recited in claim 21, further comprising incorporating a data memory and a downhole sensor command into the electrical wellhead outlet.
